(19) United States
(12) Patent Application Publication
(10) Pub. No.: US 2011/0165799 A1
(43) Pub. Date: Jul. 7, 2011

(54) ELECTRICAL CONNECTOR FOR HOLDING A LAMP

(75) Inventor: WEN-FANG WANG, Shenzhen (CN)

(73) Assignee: HON HAI PRECISION INDUSTRY CO., LTD., Tu-Cheng (TW)

(21) Appl. No.: 12/985,596

(22) Filed: Jan. 6, 2011

(30) Foreign Application Priority Data
Jan. 6, 2010 (CN) 201020300173.2

(51) Int. Cl. H01R 13/62

(52) U.S. Cl. 439/725

(57) ABSTRACT

An electrical connector includes an insulative housing, a contact and an operation member. The insulative housing defines a lamp receiving room and a board receiving room communicating with the lamp receiving room. The contact includes a retaining portion retained in the housing, a pair of first elastic arms exploding to the lamp receiving room and a second elastic arm exploding to the board receiving room. Each first elastic arm includes an inner portion and an outer portion, the inner portions defining a receiving cavity therebetween with an entrance from which a lamp is inserted to the receiving cavity and clamped by the two inner portions. The operation member defines a pair of side plates inserted in the lamp receiving room to urge free distal ends of the outer portions of the contact to press against the inner portions at positions far away from the entrance.

### BACKGROUND OF THE INVENTION

1. Field of the Invention

The present invention relates to an electrical connector, and more particularly to an electrical connector having an improved contact for fitly holding a lamp.

2. Description of the Related Art

U.S. Pat. No. 7,473,117 issued on Jan. 6, 2009 discloses an electrical connector for holding a lamp. The electrical connector comprises an insulative housing, a composite contact having a first contacting portion connecting with a lamp and a second contacting portion connecting with a print circuit board, an operation member for operating the first contacting portion of the composite contact. The first contacting portion comprises a pair of elastic arms defining a receiving room therebetween. The lamp is inserted and received in the receiving room. When the lamp is inserted into the receiving room for several times, the contact is easy to distort.

In view of the above, a new electrical connector that overcomes the above-mentioned disadvantages is desired.

### SUMMARY OF THE INVENTION

Accordingly, an object of the present invention is to provide an electrical connector having an improved contact for fitly holding a lamp.

To fulfill the above-mentioned object, an electrical connector comprises an insulative housing, a contact received in the insulative housing and an operation member. The insulative housing defines a lamp receiving room and a board receiving room communicating with the lamp receiving room. The contact comprises a retaining portion retained in the housing, a pair of first elastic arms exploding to the lamp receiving room and a second elastic arm exploding to the board receiving room. Each first elastic arm comprises an inner portion and an outer portion, the inner portions defining a receiving cavity therebetween with an entrance from which a lamp is inserted to the receiving cavity and clamped by the two inner portions. The operation member defines a pair of side plates inserted in the lamp receiving room to urge free distal ends of the outer portions of the contact to press against the inner portions at position far away from the entrance.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an electrical connector of the present invention;

FIG. 2 is an exploded view of the electrical connector of FIG. 1;

FIG. 3 is a perspective view of an insulative housing of FIG. 1;

FIG. 4 is a perspective view of a contact of FIG. 1;

FIG. 5 is a cross sectional view of the electrical connector taken along line 5-5, wherein an operation member is in an original location; and

FIG. 6 is a cross sectional view similar to FIG. 5 wherein the operation member is in a final location.

### DETAILED DESCRIPTION OF THE PREFERRED EMBODIMENT OF THE INVENTION

Reference will now be made to the drawings to describe the present invention in detail.

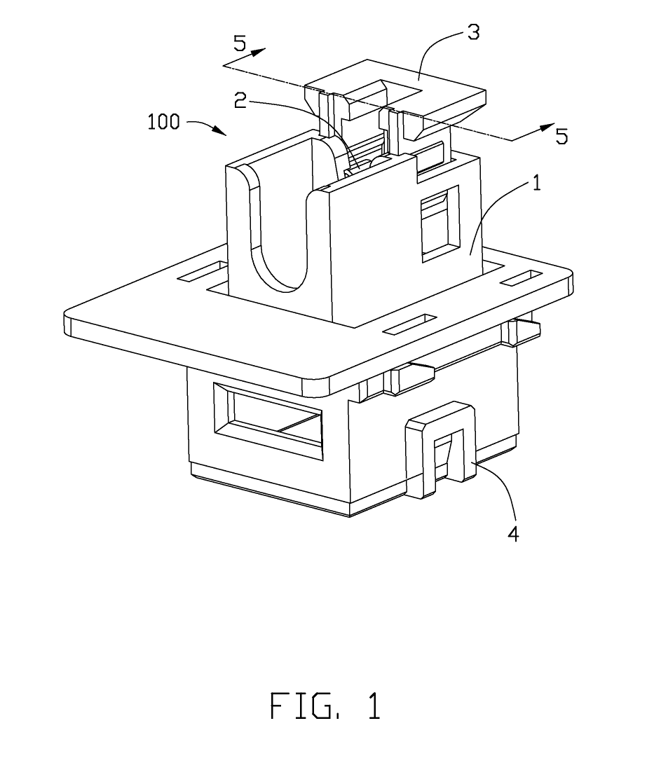

Referring to FIG. 1, an electrical connector 100 comprises an insulative housing 1, a contact 2 received in the insulative housing 1, an operation member 3 operating the contact 2 and a cover 4 assembled to a bottom of the insulative housing 1.

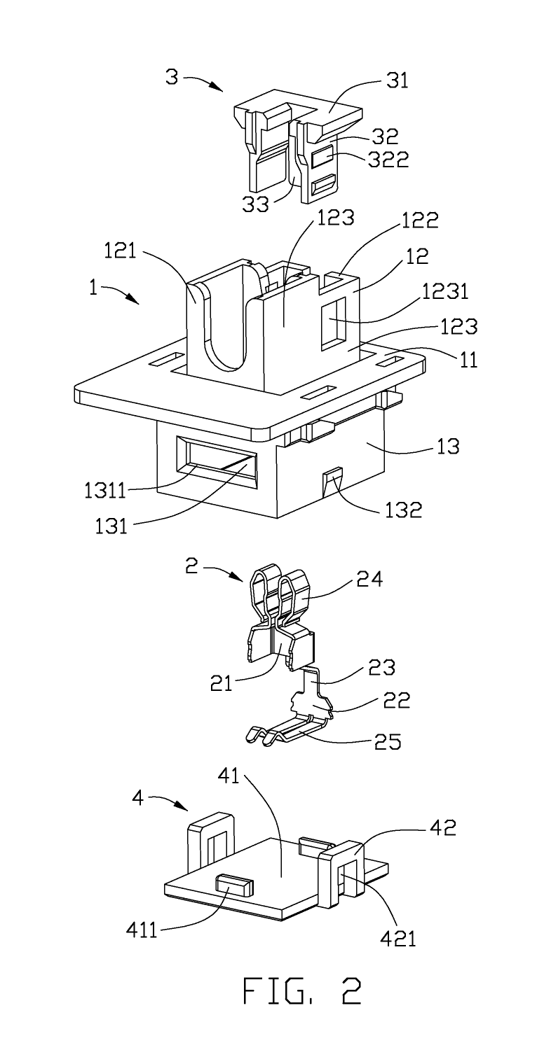

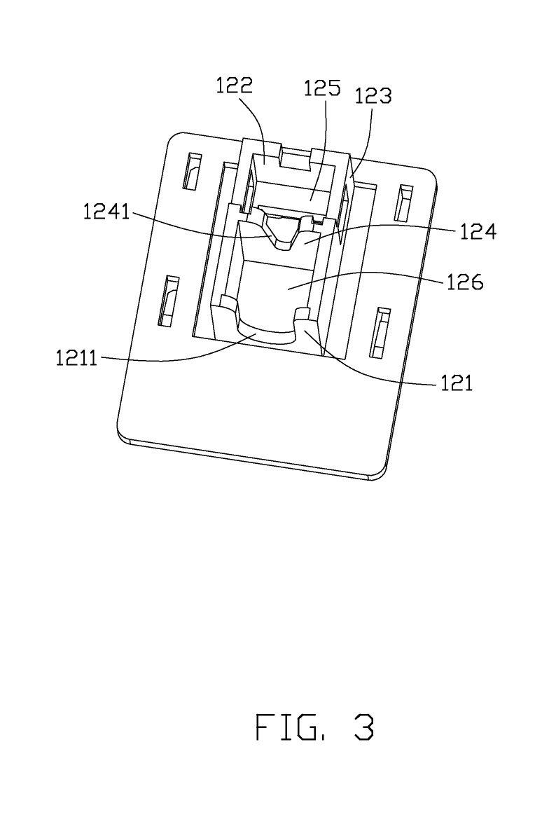

Referring to FIGS. 2 and 3, the insulative housing 1 is an integrated molded component of a synthetic resin and comprises a main body part and a flange part 11 divided the main body into two parts in a up-to-down direction, one part served as a first housing 12 for holding a lamp (not shown) and the other part served as a second housing 13 for connecting with a print circuit board (not shown). The first housing 12 is configured with a frame shape and defines a front wall 121, a back wall 122, a pair of side walls 123 and a receiving room surrounding by the four walls for receiving the lamp. The receiving room is divided into a first room 126 adjacent to the front wall 121 and a second room 125 adjacent to the back wall 122 by a partition wall 124 located between the front wall 121 and the back wall 122. The front wall 121 forms a first cutout 1211 of U-shaped and the partition wall 124 forms a second cutout 1241 of U-shaped corresponding to the first cutout 1211. The second cutout 1241 for holding a conductive pole of the lamp has a smaller dimension than the first cutout 1211 for holding a plastic layer of the lamp. The second housing 13 is configured with a rectangle shape and defines a third room 131 receiving the print circuit board and communicating with the second room 125 in the up-to-down direction. The contact 2 is received in the third room 131 and the second room 125. The second housing 13 further defines a window 1311 through which the print circuit board is inserted into the third room 131 and contacting with the contact 2.

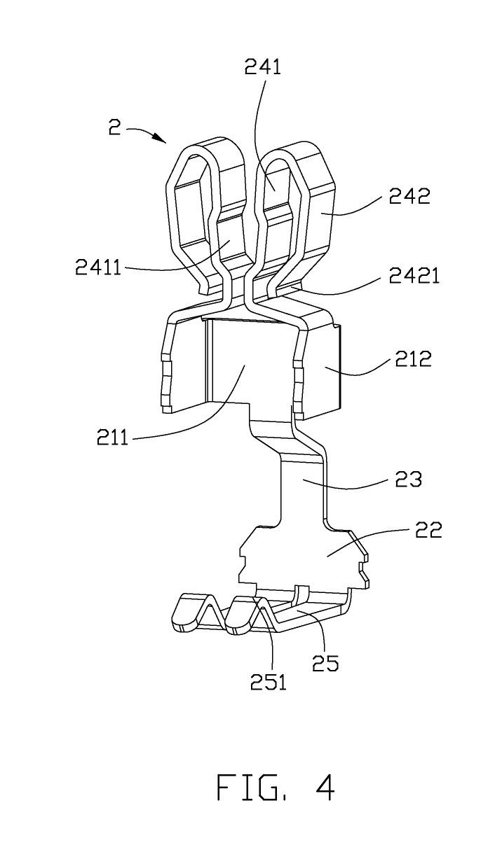

Referring to FIGS. 2 and 4, the contact 2 comprises a first retaining portion 21, a second retaining portion 22 of plate shaped, a connecting portion 23 bridging the first retaining portion 21 and the second retaining portion 21, a pair of first elastic arms 24 extending upward from the first retaining portion 21 and a pair of second elastic arms 25 extending downward from the second retaining portion 22. The first retaining portion 21 and the second retaining portion 22 respectively forms a plurality of barbs through which the contact 2 is engaged with the insulative housing 1 to secure the contact 2 in the insulative housing 1. The first retaining portion 21 is configured with U-shaped and comprises a first wall 211 and a pair of second walls 212 at two sides of the first wall 211. The two first elastic arms 24 extend to each other from the second walls 212 and are mirror symmetrical. The first elastic arms 24 are received in the second room 125 and each comprises an inner portion 241 adjacent to the other first elastic arm 24 and an outer portion 242 bending downward from a top of the inner portion 241. The inner portions 241 partly bend toward the corresponding outer portions 242 to form a receiving cavity 2411 therebetween with an entrance from which the lamp is inserted to the receiving cavity 2411 and clamped by the inner portions 241. The connecting portion 23 extends deviously and is narrower than the first retaining portion 21 and the second retaining portion 22. The second elastic arms 25 comprise a pair of contacting portions 251 contacting with the print circuit board.

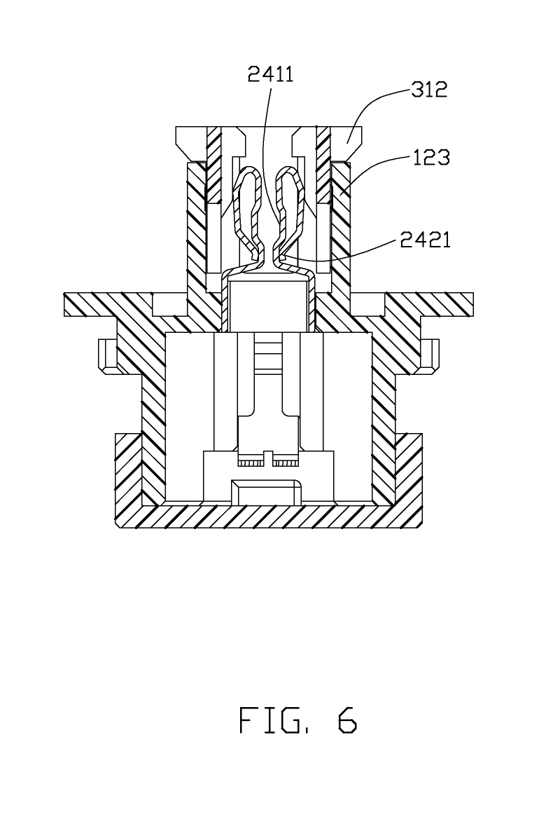

Referring to FIGS. 2, 5 and 6, the operating member 3 comprises a top plate 31, a pair of side plates 32 extending downward from the top plate 31 and a back plate 33. The top plate 31 comprises a pair of first tubers 311 extending outward from the two side plates 32 and a pair of second tubers 312 extending inward from the two side plates 32. The first tubers 312 abut against the side walls 123 of the insulative housing 1 and the second tubers 312 are located just above the first elastic arms 24 of the contact 2. When the operating member 3 is inserted into the insulative housing 1, the side plates 32 urge free distal ends 2421 of the outer portions 242 to press against the inner portion 241 at a position below the receiving cavities 2411. The side plates 32 abut against positions of the outer portions 242 above the free distal ends 2421.

Each side plate 32 of the operating member 3 further defines a pair of protrusions 322 arranged in the up-to-down direction. The side walls 123 of the insulative housing 1 respectively define grooves 1231 cooperated with the two protrusions 322 to secure the operating member 3 in the insulative housing 1.

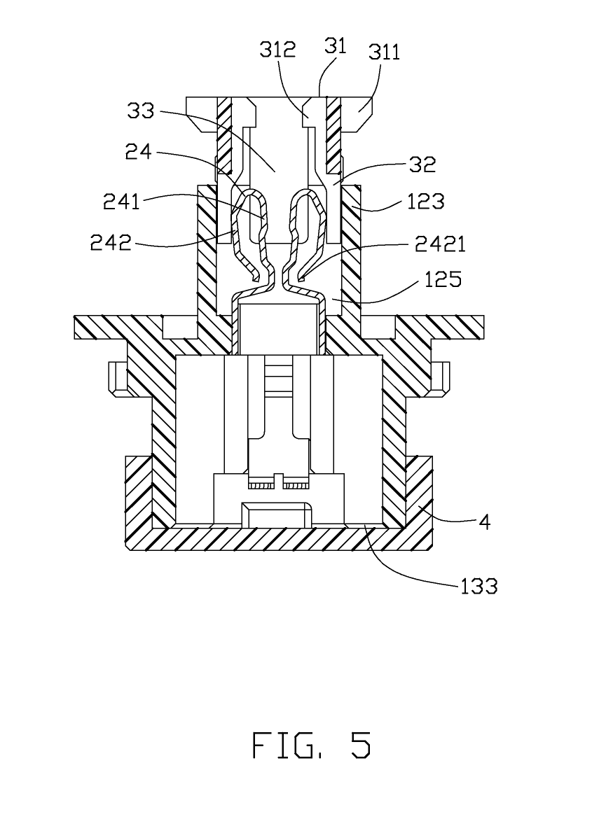

Referring to FIGS. 2 and 5, the second housing 13 defines an opening 133 at the bottom. The cover 4 is assembled to shield the opening 133. The cover is made of a synthetic resin and comprises a plate portion 41 shielding the opening 133, a pair of locking ears 42 with through holes 421 locked with blocks 132 defined on outsides of the second housing 13 to secure the cover 4 to the insulative housing 1 and two positioning ribs 411 resisting on insides of the second housing 13.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector comprising:
an insulative housing defining a lamp receiving room and a board receiving room communicating with the lamp receiving room;
a contact comprising a retaining portion retained in the housing, a pair of first elastic arms exploding to the lamp receiving room and a second elastic arm exploding to the board receiving room, each first elastic arm comprising an inner portion and an outer portion, the inner portions defining a receiving cavity therebetween with an entrance from which a lamp is inserted to the receiving cavity and clamped by said two inner portions;
an operation member defining a pair of side plates inserted in the lamp receiving room to urge free distal ends of the outer portions of the contact to press against the inner portions at positions far away from the entrance.

2. The electrical connector as claimed in claim 1, wherein said positions of the inner portions are disposed below the receiving cavity.

3. The electrical connector as claimed in claim 2, wherein the side plate abuts against the outer portion at a position above the free distal end.

4. The electrical connector as claimed in claim 3, wherein the operation member defines an opening aligned with the entrance of the contacts.

5. The electrical connector as claimed in claim 4, wherein the operation member defines a pair of protrusions at outer sides of the side plate to be retained in grooves of the insulative housing.

6. The electrical connector as claimed in claim 1, wherein the operation member defines a first tuber located above the first elastic arms and a second tuber abutting against the insulative housing, the first and second tubers located at two opposite sides of the side plate.

7. The electrical connector as claimed in claim 1, wherein the lamp receiving room is divided into two parts by a partition wall, the partition wall defines a first cutout for holding a conductive pole of the lamp.

8. The electrical connector as claimed in claim 7, wherein the insulative housing defines a side wall parallel with the partition wall and defines a second cutout corresponding to the first cutout while having a larger dimension than the first cutout.

9. The electrical connector as claimed in claim 1, wherein the insulative housing defines a window through which a board is inserted into the board receiving room and contacting with the second elastic arm.

10. The electrical connector as claimed in claim 1, wherein the insulative housing defines an opening at a bottom, the electrical connector further comprises a cover made of a synthetic resin assembled to shield the opening

11. An electrical connector comprising:
an insulative housing defining a lamp receiving room and a board receiving room communicating with each other in a vertical direction;
a contact comprising a lamp contacting section and a board contacting section respectively equipped with corresponding retaining sections which are spaced from each other while connected by a connection portion extending along not only said vertical direction but also a longitudinal direction perpendicular to said vertical direction, said lamp contacting section defining a pair of elastic arms spaced from each other in a transverse direction perpendicular to both said vertical direction and said longitudinal direction, each of said elastic arms including an inner portion and an outer portion backwardly folded from the inner portion, the inner portions commonly defining a receiving cavity therebetween in the transverse direction for receiving a lamp therein; and
an operation member received in the lamp receiving room and pressing the corresponding outer portions inwardly to actuate the corresponding inner portions to move closer to each other and narrow the receiving cavity for efficiently sandwiching the lamp therebetween.

12. The electrical connector as claimed in claim 11, wherein the outer portion and the corresponding inner portion commonly form a closed loop structure when the operation member is received in the lamp receiving room to enhance clamping function of the inner portions with regard to the lamp.

13. The electrical connector as claimed in claim 12, wherein a free end of the outer portion abuts against the corresponding inner portion to form said closed loop structure.

14. The electrical connector as claimed in claim 13, wherein a position where the free end of the outer portion abuts against the corresponding inner portion, is located intimately below the receiving cavity.

15. The electrical connector as claimed in claim 14, wherein the inner portion forms a recess at said position to receive the free end of the corresponding outer portion.

16. The electrical connector as claimed in claim 12, wherein said closed loop structure is open due to resiliency of the outer portion and the inner portion when the operation member is not received in the lamp receiving room.

17. The electrical connector as claimed in claim 12, wherein said operation member is inserted into the lamp receiving room in the vertical direction to inward deflect the corresponding outer portions.
